(19) United States
(12) Patent Application Publication
(10) Pub. No.: US 2019/0383738 A1
(43) Pub. Date: Dec. 19, 2019

(54) FLUORESCENCE DETECTION SENSOR

(71) Applicant: SHARP KABUSHIKI KAISHA, Sakai City (JP)

(72) Inventors: DAIKI SATO, Sakai City (JP); TAKESHI MITSUNAKA, Sakai City (JP)

(21) Appl. No.: 16/441,797

(22) Filed: Jun. 14, 2019

Related U.S. Application Data
(60) Provisional application No. 62/685,495, filed on Jun. 15, 2018.

(51) Int. Cl. G01N 21/64; G02B 5/30

(52) U.S. Cl. CPC G01N 21/645; G01N 2021/6471; G02B 5/3058

(57) ABSTRACT

A fluorescence detection sensor includes an excitation light source that irradiates an inspection target with excitation light, a semiconductor integrated circuit provided with a photon detection portion that detects light by a photodiode, and a control unit that causes the inspection target maintained on the photodiode to be irradiated with the excitation light, and detects, by the photon detection portion, fluorescence emitted from the inspection target after the excitation light is quenched. An optical filter formed by a metal wiring layer which is one of components of the semiconductor integrated circuit, is provided above the photon detection portion.

### BACKGROUND

### 1. Field

The present disclosure relates to a fluorescence detection sensor that detects a fluorescence reaction, and a fluorescence detection system using the fluorescence detection sensor.

### 2. Description of the Related Art

As one of detection techniques used in a research and a clinical examination in biology and medicine, or the like, there is a detection technique using fluorescence. The fluorescence is a light that is emitted when a molecule or an ion that has fallen into an intermediate excitation state returns to a ground state after absorbing excitation light (for example, ultraviolet light or visible light) and entering the excitation state from the ground state, and is a light that has a longer wavelength than that of the excitation light.

Among the widely used fluorescence detection techniques, there is a technique of detecting fluorescence emitted from an inspection target while irradiating the inspection target with excitation light. More specifically, utilizing a difference between a wavelength of the excitation light and a wavelength of the fluorescence, the fluorescence is detected by separating the fluorescence emitted from the inspection target and the excitation light reflected by a target object, via an optical filter.

For example, as illustrated in FIG. 10, a fluorescence measurement apparatus 101 disclosed in Japanese Unexamined Patent Application Publication No. 2017-156310 is configured to include an excitation light outgoing portion 102, a polarized light separation portion 103, an optical fiber 104, and a spectroscopic portion 105. In the fluorescence measurement apparatus 101, it is configured such that the excitation light output from the excitation light outgoing portion 102 and excitation light having polarization characteristics reflected by an inspection target are attenuated by the polarized light separation portion 103, and the fluorescence emitted from a measurement object 106 which is excited by the excitation light is selectively incident on the optical fiber 104 and guided to the spectroscopic portion 105.

As illustrated in FIG. 11, a fluorescence sensor 111 disclosed in Japanese Unexamined Patent Application Publication No. 2017-215273 includes a light waveguide 113 formed on a substrate 112 and a photodiode 114 formed below the light waveguide 113 and in the substrate 112. In a detection region provided in the light waveguide 113, a core 115 on a cladding layer 117 constituting the light waveguide 113 is exposed and can be in contact with a phosphor. A filter layer 116 for attenuating the excitation light is disposed between the photodiode 114 and the core 115.

In the fluorescence measurement apparatus 101 illustrated in Japanese Unexamined Patent Application Publication No. 2017-156310, the polarized light separation portion 103 is disposed independently of the spectroscopic portion 105, and the fluorescence excited by the excitation light from the excitation light outgoing portion 102 and emitted from the measurement object 106 is guided to the spectroscopic portion 105 via the optical fiber 104. For this reason, there is a problem that a yield of the fluorescence in the spectroscopic portion 105 is lowered due to a coupling loss by a positional relationship of each component, a reflection loss at an end surface of the optical fiber 104, and an absorption loss in the core.

Further, in the fluorescence sensor 111 illustrated in Japanese Unexamined Patent Application Publication No. 2017-215273, since a scattered light leaked from the core 115 of the light waveguide 113 is used as excitation light, the excitation light incident on a light absorbing portion 118 of the photodiode 114 does not have a polarization property and a regular incident angle. In order to attenuate such excitation light, the filter layer 116 is assumed to be, for example, an absorption type filter formed by spin coating a material containing an organic dye.

A fluorescence detection system illustrated in WO 2019/026413 A1 includes an integrated circuit chip 121 that incorporates a photon detection portion including a photodiode 23, a micro flow path 10 formed on the integrated circuit chip 121, an excitation light source 50 that irradiates the micro flow path with excitation light, and a control circuit (not shown) that synchronously controls an irradiation operation of the excitation light source 50, and the photodiode 23 is operated to detect a fluorescence photon generated from an inspection target flowing in the micro flow path after quenching of the excitation light with which the micro flow path 10 is irradiated by controlling an operation of the photon detection of the photon detection portion 21 based on an irradiation timing of the excitation light source.

However, manufacturing a fluorescence sensor including this type of filter layer has a problem that cost for forming the filter layer is increased as compared to a fluorescence sensor not including the filter layer. In addition, when a plurality of types of fluorescence sensors are disposed in the same substrate, a plurality of types of filters having different absorption spectra have to be allocated for the different fluorescence sensors in the same substrate, resulting in difficulty of manufacturing and it is not able to demonstrate a separation effect on the excitation light other than a specific wavelength band. Therefore, there is also a problem that it is not suitable for a fluorescence measurement using a plurality of types of excitation light.

It is desirable to provide a fluorescence detection sensor with high detection sensitivity that can separate excitation light from fluorescence via an optical filter and increase an yield of the fluorescence, and can be manufactured at low cost and also provide a fluorescence detection system using the fluorescence detection sensor.

### SUMMARY

(1) According to an aspect of the present disclosure, there is provided a fluorescence detection sensor including: an excitation light source that irradiates an inspection target with excitation light; a semiconductor integrated circuit provided with a photon detection portion that detects light by a photodiode; and a control unit that causes the inspection target maintained on the photodiode to be irradiated with the excitation light, and detects, by the photon detection portion, fluorescence emitted from the inspection target after the excitation light is quenched, in which an optical filter formed by a metal wiring layer which is one of components of the semiconductor integrated circuit, is provided above the photon detection portion.

### BRIEF DESCRIPTION OF THE DRAWINGS

FIGS. 1A and 1B are explanatory views illustrating a configuration of a fluorescence detection sensor according to Embodiment 1 of the present disclosure;

FIGS. 2A, 2B, and 2C are examples of a result illustrated using a time-correlated single photon counting method in a photon detection portion;

FIG. 3 is a top view illustrating an example of an optical filter in the fluorescence detection sensor;

FIG. 4 is an explanatory view illustrating an operation of the optical filter illustrated in FIG. 3;

FIGS. 5A and 5B are explanatory views in which optical filters and photon detection portions are arranged in an array form;

FIGS. 6A, 6B, and 6C are top views illustrating an example of an optical filter in a fluorescence detection sensor according to Embodiment 2 of the present disclosure;

FIG. 7 is an explanatory view illustrating a configuration of the fluorescence detection system provided with the fluorescence detection sensor according to the embodiment;

FIG. 8 is an explanatory view illustrating a configuration of a fluorescence detection sensor according to Embodiment 3 of the present disclosure;

FIG. 9 is an explanatory view of a case where a part of wiring of the optical filter is utilized as a dielectrophoretic electrode;

FIG. 10 is an explanatory view illustrating a configuration of a fluorescence measurement apparatus of an example in the related art; and

FIG. 11 is a cross-sectional view illustrating a configuration of a fluorescence sensor of an example in the related art.

### DESCRIPTION OF THE EMBODIMENTS

Hereinafter, a fluorescence detection sensor and a fluorescence detection system according to embodiments of the present disclosure will be described with reference to the drawings.

### Embodiment 1

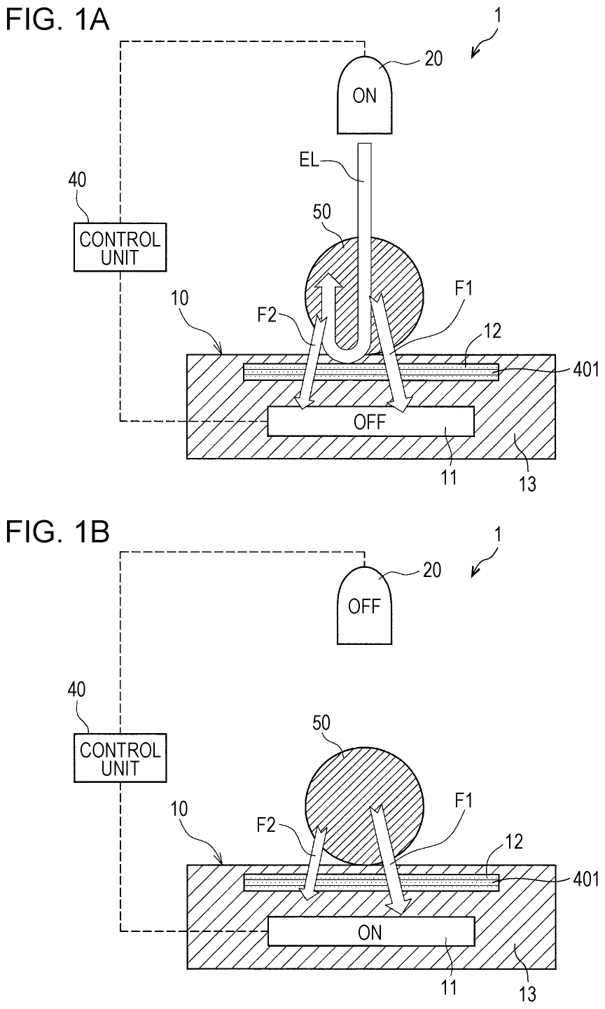

FIGS. 1A and 1B are explanatory views illustrating a configuration of a fluorescence detection sensor 1 according to Embodiment 1. The fluorescence detection sensor 1 includes an excitation light source 20 and a semiconductor integrated circuit 13 including a photon detection portion 11 formed on a semiconductor substrate 10. In FIGS. 1A and 1B, a configuration of the fluorescence detection sensor 1 is schematically illustrated in a cross section.

The excitation light source 20 is a light source that irradiates an inspection target 50 with excitation light (laser light) EL in a pulse form, and a drive of the excitation light source 20 is controlled by a control unit 40. The semiconductor integrated circuit 13 generates transistors and other circuit elements on a surface of a semiconductor substrate 10 or in the semiconductor substrate 10 and is configured in an inseparable state, and has a function of an electronic circuit.

The photon detection portion 11 is configured with a photodiode, more specifically, a single photon avalanche photodiode (abbreviated as SPAD), and detects a photon of fluorescence F generated by irradiating the inspection target 50 with the excitation light EL. For example, the photon detection portion 11 includes a PN junction diode for detecting a photon, and generates a pulse signal when the photon is incident in a state in which a reverse bias voltage VSPAD higher than or equal to a breakdown voltage is applied.

The control unit 40 controls a drive of each portion of the fluorescence detection sensor 1 and controls a timing of the drive thereof, and, for example, synchronously controls the excitation light source 20 and the photon detection portion 11 of the fluorescence detection sensor 1. Thereby, the excitation light source 20 irradiates the inspection target 50 with the excitation light EL in a pulse form under a control of the control unit 40. Further, by the control unit 40, after the quenching of the excitation light EL, the fluorescence F emitted from the inspection target 50 is detected by the photon detection portion 11. In the present disclosure, by disposing the optical filter 12 above the photon detection portion 11, the excitation light EL is not incident on the photon detection portion 11. The optical filter 12 is configured to include a metal wiring layer 401 that constitutes the semiconductor integrated circuit 13.

Hereinafter, an operation of the fluorescence detection sensor 1 of the present disclosure will be described.

As illustrated in FIG. 1A, the control unit 40 drives the excitation light source 20 (ON).

The excitation light source 20 irradiates the inspection target 50, which emits fluorescence corresponding to a wavelength of the excitation light source 20, with the excitation light EL. The inspection target 50 irradiated with the excitation light EL emits the fluorescence F. Here, a fluorescence intensity I of the phosphor in the inspection target 50 depends on an emission intensity of the excitation light source 20, and a change in time thereof can be calculated by following Expression 1 with reference to a regular value (I₀).

I=I₀e^{-t/τ} Expression 1

The phosphor continues to emit the fluorescence F even after the excitation light source 20 is turned off, but the fluorescence intensity I attenuates as time passed. The time taken for the fluorescence intensity I to decrease to 1/e as compared to the moment or immediately after the fluorescence F is excited, is defined as a fluorescence lifetime τ of the phosphor. Note that I₀ is a fluorescence intensity at time t=0, and e is a natural logarithm.

As illustrated in FIG. 1A, at a stage of driving the excitation light source 20 of the fluorescence detection sensor 1, the photon detection portion 11 is not driven and is not in operation (OFF). In this state, when inspection target 50 is irradiated with the excitation light EL in a pulse form, a primary fluorescence F1 is emitted from the inspection target 50 excited by the excitation light EL.

By disposing the optical filter 12 above the photon detection portion 11, the excitation light EL is reflected by the optical filter 12 that functions as a polarizer. In contrast to this, the primary fluorescence F1 emitted from the inspection target 50 is selectively guided to the photon detection portion 11 because the polarization direction and an angle are random. The transmittance of the optical filter 12 for the primary fluorescence F1 is considered to be sufficiently higher than the transmittance for the excitation light EL.

The excitation light EL reflected by the optical filter 12 is incident on the inspection target 50 again. The inspection target 50 excited by the excitation light EL incident again emits secondary fluorescence F2. The secondary fluorescence F2 is also guided to the photon detection portion 11 in the same manner as the primary fluorescence F1. As a result, the excitation light EL and the fluorescence F (primary fluorescence F1 and secondary fluorescence F2) are separated, and the photon detection portion 11 can effectively detect the fluorescence F.

Next, as illustrated in FIG. 1B, the excitation light source 20 is turned off (OFF) by the control of the control unit 40, and the excitation light EL is quenched. When a light emitting pulse of the excitation light EL disappears, the control unit 40 drives the photon detection portion 11 and the operation is started (ON). The operation is started in the photon detection portion 11 immediately after the light emitting pulse of the excitation light EL disappears. At this time, ideally, the excitation light EL is not directly detected by the photon detection portion 11 since the excitation light EL is quenched, but depending on the configuration of the photon detection portion 11, a photon of the excitation light EL remains in the photon detection portion 11 at the timing illustrated in FIG. 1A, and a phenomenon occurs in which the excitation light EL is detected by the photon detection portion 11 at the timing illustrated in FIG. 1B.

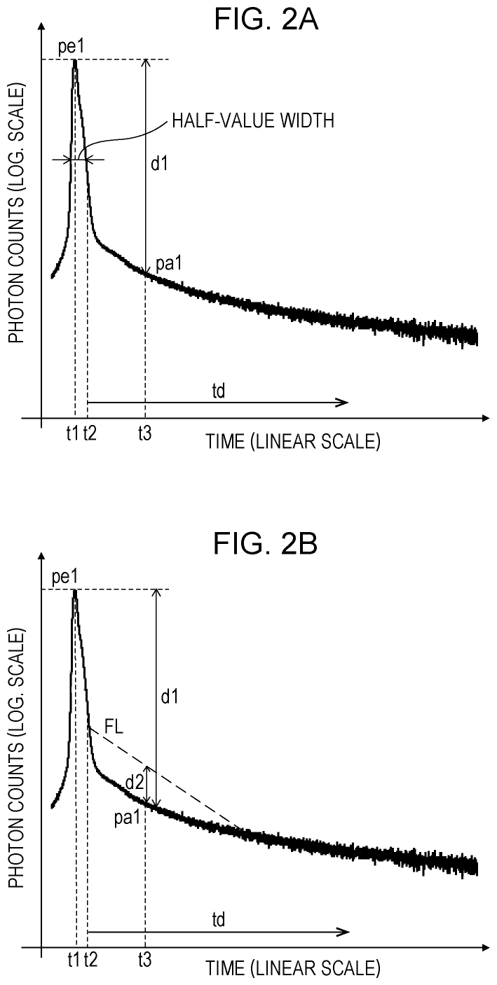

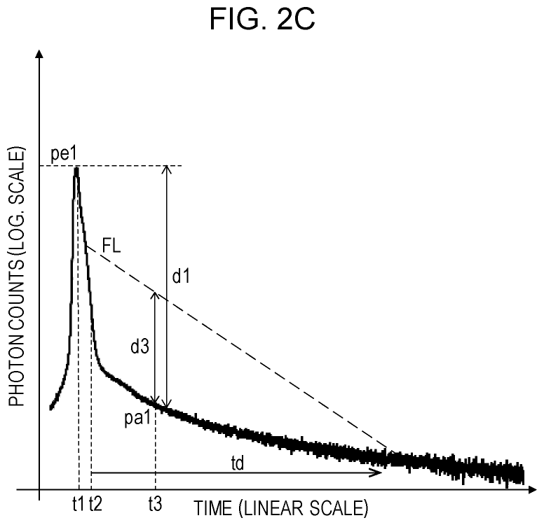

FIG. 2A is an example of a result illustrated using a time-correlated single photon counting method when the inspection target 50 does not exist in the photon detection portion 11 in accordance with the operation in FIGS. 1A and 1B. After the excitation light source 20 is irradiated at the timing of time t1, the excitation light source 20 is turned off after time t2, but at this time there is a section td in which residual photons are detected with a time difference, and an after pulse phenomenon is observed. Assuming that the time for detecting the fluorescence F is t3, a detection difference d1 between a photon detection value pa1 in the after pulse phenomenon and a photon detection value pe1 when the excitation light EL with which the inspection target is irradiated, is the maximum sensitivity for detecting the fluorescence F with respect to the excitation light EL at time t3.

The after pulse phenomenon is an inherent property determined by the SPAD constituting each photon detection portion 11, and the detection difference d1 does not change depending on the intensity of the excitation light EL. Therefore, when the optical filter 12 is not disposed above the photon detection portion 11, the excitation light EL is directly incident on the photon detection portion 11 in the OFF state. A result illustrated using the time-correlated single photon counting method at this time is illustrated in FIG. 2B. Since the detection difference d1 is maintained by the photons remaining on the SPAD of the photon detection portion 11, when the inspection target 50 is disposed, the fluorescence F of the inspection target 50 is observed as a fluorescence life line FL. Since the excitation light EL is also incident on the photon detection portion 11, a difference (d2) between the fluorescence lifetime line FL and the photon detection value pa1, which is a noise level at time t3, is small, and this makes a detection difficult.

In contrast to this, when the optical filter 12 is disposed above the photon detection portion 11, although an amount of the fluorescence F emitted from the inspection target 50 is equal since the amount of photons of the excitation light EL incident on the inspection target 50 is equivalent, an incident amount on the photon detection portion 11 decreases by the optical filter 12. A result illustrated using the time-correlated single photon counting method at this time is illustrated in FIG. 2C. Since the photons remaining on the SPAD of the photon detection portion 11 decrease while maintaining the fluorescence lifetime line FL, a total photon counting itself decreases, so the excitation light EL and the fluorescence F can be effectively separated by increasing the difference (d3) between the fluorescence lifetime line FL and the photon detection value pa1, which is a noise level at time t3, and it becomes possible to perform a highly sensitive fluorescence detection in a state where noise components are reduced.

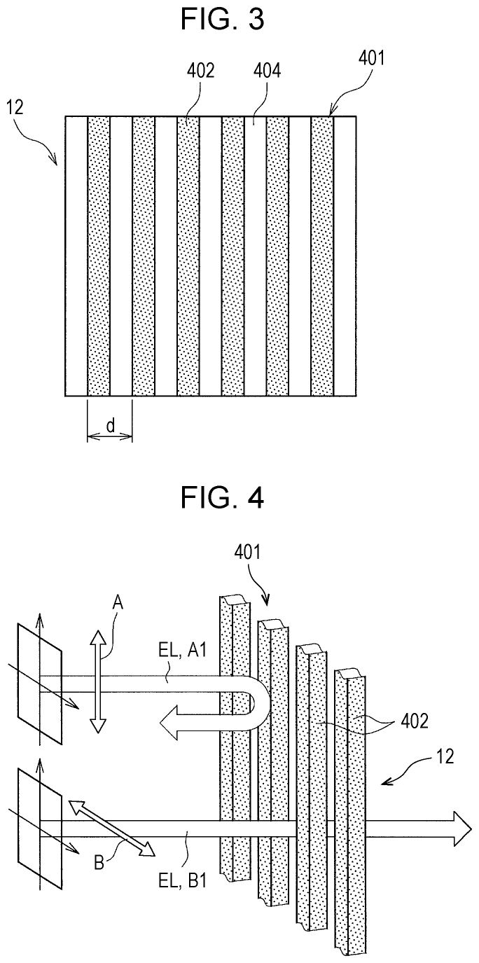

FIG. 3 is a top view illustrating an example of the optical filter 12 in the fluorescence detection sensor 1, and FIG. 4 is an explanatory view illustrating an operation of the metal wiring layer 401 of the optical filter 12. In the embodiment illustrated in FIG. 3, the optical filter 12 is a polarizer having a wire grid structure, and includes the metal wiring layer 401 including a metal wire 402. In the metal wiring layer 401, a plurality of metal wires 402 are arranged in parallel at regular intervals, and a formation pattern is a strip shape (one-dimensional lattice shape).

More specifically, the metal wiring layer 401 of the optical filter 41 has a wire grid structure by arranging the plurality of metal wires 402 in parallel. As the metal wire 402, normal metal wiring that constitutes the semiconductor integrated circuit 13 can be applied. An arrangement period d of the metal wire 402 is a distance sufficiently shorter than a wavelength of the excitation light EL emitted from the excitation light source 20. Further, a part of the optical filter 41 where the metal wire 402 is not arranged is filled with an insulating film 404 (insulating film layer 403) such as a silicon oxide or a silicon nitride.

As illustrated in FIG. 4, the optical filter 12 operates as a polarizer with respect to a light having a wavelength greater than or equal to that of the excitation light EL. That is, when the excitation light EL is perpendicularly incident on the optical filter 12, light A1 whose polarization direction is parallel to the metal wire 402 as illustrated by an arrow A, is reflected on the metal wiring layer 401 by the vibration of free electrons in the metal wire 402. Further, light B1 whose polarization direction is orthogonal to the metal wire 402 as illustrated by an arrow B, passes through the metal wiring layer 401 since the vibration of free electrons does not occur. The optical filter 12 has optical characteristics as such a polarizer.

In the fluorescence detection sensor 1, the optical filter 12 is provided in the semiconductor integrated circuit 13 so that the excitation light EL is perpendicularly incident on the semiconductor substrate 10. Also, the excitation light source 20 and the semiconductor substrate 10 are provided with their arrangement positions adjusted so that a polarization direction of the optical filter 12 is parallel to the metal wire 402 (the arrow A direction illustrated in FIG. 4).

### Measurement Sequence of Fluorescence Detection Sensor 1

The fluorescence detection sensor 1 detects the fluorescence F emitted from the inspection target 50 based on a prescribed measurement sequence. As illustrated in FIGS. 1A and 1B, the inspection target 50 is disposed above the photon detection portion 11 and on the semiconductor substrate 10. When the excitation light EL from the excitation light source 20 is incident on the inspection target 50, a primary fluorescence F1 is emitted from the inspection target 50 excited by the excitation light EL.

The excitation light EL is reflected by the optical filter 12 that functions as a polarizer. In contrast to this, the primary fluorescence F1 emitted from the inspection target 50 is selectively guided to the photon detection portion 32 because the polarization direction and an angle are random. The transmittance of the optical filter 12 for the primary fluorescence F1 is considered to be sufficiently higher than the transmittance for the excitation light EL.

The excitation light EL reflected by the optical filter 12 is incident on the inspection target 50 again. The inspection target 50 excited by the excitation light EL incident again emits a secondary fluorescence F2. The secondary fluorescence F2 is also guided to the photon detection portion 11 in the same manner as the primary fluorescence F1. As a result, the excitation light EL and the fluorescence F (primary fluorescence F1 and secondary fluorescence F2) are separated, and the photon detection portion 32 can effectively detect the fluorescence F.

Note that the inspection target 50 may be particles existing in a space, cells, biomolecules, fluorescent beads, or the like, and is not particularly limited. Further, the inspection target 50 may be in a state of being dispersed or dissolved in a liquid. Application Example of Fluorescence Detection Sensor 1

In the fluorescence detection sensor 1 having the above-described configuration, since the optical filter 12 has optical characteristics sufficiently operating as a polarizer for a specific wavelength λ, it is possible to operate as a polarizer for light with a wavelength longer than the wavelength λ. Therefore, the fluorescence detection sensor 1 can be applied to fluorescence detection using excitation light EL with different wavelengths without desiring a special design change.

For example, one fluorescence detection sensor 1 irradiated sequentially with the excitation light EL of a plurality of wavelengths can be utilized for identification of a plurality of types of phosphors having different excitation light wavelengths. As an example, a case where the fluorescence detection sensor 1 is applied for discrimination of two different types of cells will be described.

First, two types of cells are dyed with two types of fluorescent labeling reagent fluorescein isothiocyanate (FITC) excited by a blue light and fluorescent labeling reagent Texas Red excited by a red light. Further, as the excitation light source 20 in the fluorescence detection sensor 1, blue and red lasers are configured to be incident on the semiconductor substrate 10.

In this case, one dyed cell is irradiated with the excitation light EL from the excitation light source 20 as the inspection target 50, and when the fluorescence F is detected by the excitation light EL of a blue color, it is determined that the inspection target 50 is a cell dyed with the FITC. Further, when the fluorescence F is detected by the excitation light EL of a red color, it is determined that the inspection target 50 is a cell dyed with Texas Red. The fluorescent labeling reagent to be added to the cells is not particularly limited, and, for example, in addition to FITC and Texas Red, RITC, Rhodamine, TET, TAMRA, FAM, HEX, ROX, or the like can be used.

As described above, according to the fluorescence detection sensor 1, a flexible design that does not limit a wavelength of the excitation light EL is possible, so that the optical filter 12 can be configured without a difficulty of manufacturing, and an effective separation of the excitation light EL and the fluorescence F is possible, so that an yield of the fluorescence F can be enhanced. As a result, detection sensitivity of the fluorescence F can be significantly improved. Further, by irradiating the inspection target 50 with the excitation light EL having an appropriate wavelength according to the inspection target 50, the fluorescence F emitted from the inspection target 50 can be observed to enable more detailed detection.

Note that, regarding the fluorescence detection sensor 1, although the configuration in which the excitation light source 20 is disposed right above the semiconductor substrate 10 has been described in the embodiment illustrated in FIGS. 1A and 1B, the present disclosure is not limited to this, and, for example, the light path may be designed using a mirror or the like so that the excitation light EL is vertically incident on the semiconductor substrate 10. Further, although the optical filter 12 is configured to include both the metal wiring layer 401 and the insulating film layer 403, it may be configured to include at least one of the metal wiring layer 401 and the insulating film layer 403.

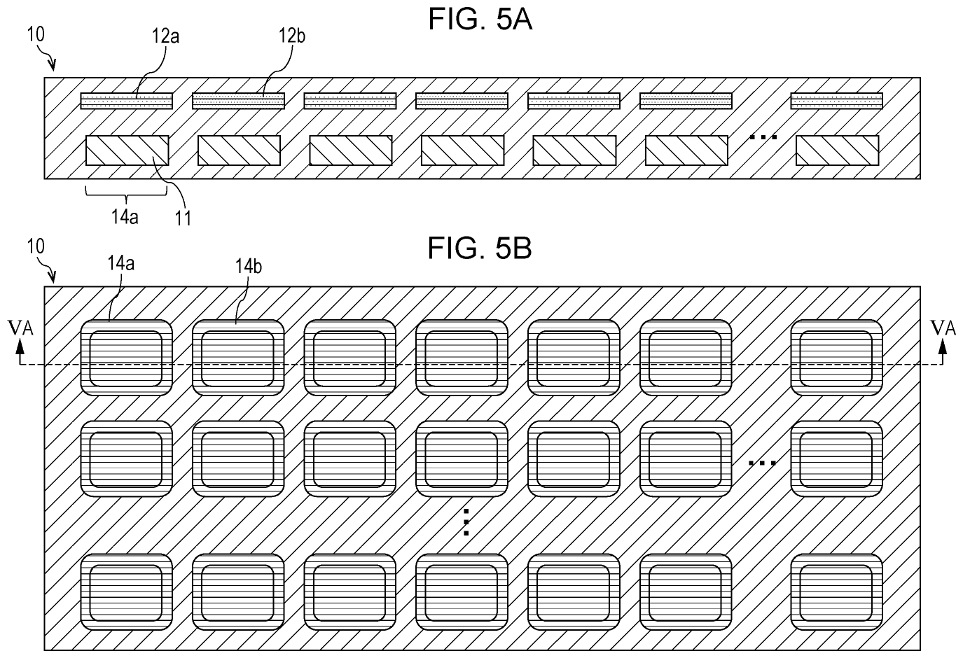

Next, FIGS. 5A and 5B illustrate a configuration in which a plurality of the fluorescence detection sensors 1 illustrated in FIGS. 1A and 1B are arranged in an array form. FIG. 5A is a sectional view taken along line VA-VA in FIG. 5B. The optical filter 12 and the photon detection portion 11 are configured as one unit 14 and arranged in an array form. An optical filter 12a of a unit 14a is arranged separately from an optical filter 12b of another unit 14b, and it is considered that the unit 14b is not irradiated with the excitation light EL and the fluorescence F with which the unit 14a is irradiated. By arranging a plurality of inspection targets 50 on corresponding units 14, it is possible to detect many inspection targets 50 at one time, which can lead to shortening of an evaluation time.

### Embodiment 2

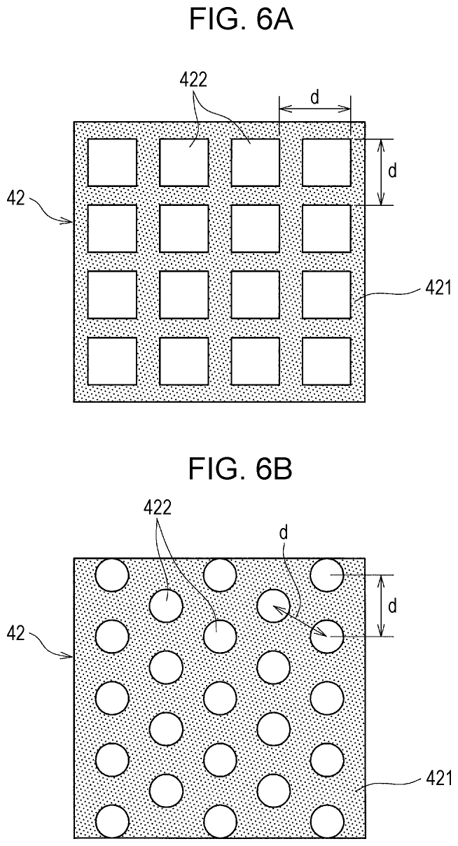

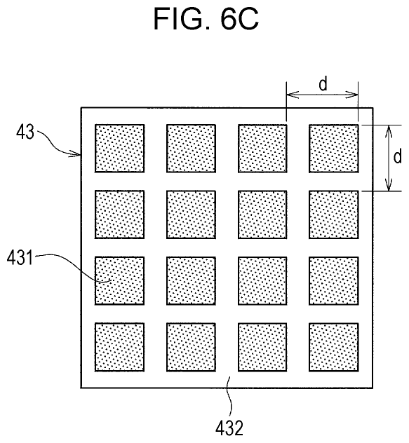

FIGS. 6A and 6B are top views each illustrating an optical filter 42 in the fluorescence detection sensor 1 according to Embodiment 2.

In the fluorescence detection sensor 1 according to this embodiment, a configuration of an optical filter 42 has characteristics, and the other basic configuration is the same as the configuration illustrated in FIGS. 1A and 1B in Embodiment 1. In the description in each of the following embodiments including Embodiment 2, the same reference symbols as those described in Embodiment 1 are used for the same configuration as Embodiment 1, and the redundant description is omitted, and the configuration specific to the embodiment will be described in detail.

As illustrated in FIG. 6A, as for the optical filter 42 in the fluorescence detection sensor 1, a metal wiring layer 421 has a metal mesh structure. The metal wiring layer 421 is configured, for example, by arranging a plurality of thin wires or metal wires formed of metal materials in parallel at regular intervals in a vertical direction and a horizontal direction, thereby, the metal wiring layer 421 has a metal mesh structure (inductive mesh structure) with an arrangement period d in which a plurality of opening holes 422 are arranged at equal intervals in the vertical and horizontal directions.

The opening holes 422 of the optical filter 42 have a rectangular shape in the example illustrated in FIG. 6A, and have a form of a lattice shape arrangement as a whole. The shape of such an opening hole 422 is not limited to a rectangular shape, and may be a circular shape or a triangular shape.

Further, the arrangement form of the opening holes 422 is not limited to the form in which the opening holes 422 are equally arranged in the vertical direction and the horizontal direction, and may be in a staggered arrangement (staggered grid arrangement) as illustrated in FIG. 6B. In the optical filter 42 illustrated in FIG. 6B, a plurality of opening holes 422 having a circular shape are provided, and it is configured as a metal mesh structure of a staggered arrangement with an arrangement period d in which a center interval between the nearest opening holes 422 is made regular. Metal mesh finishing is performed on the plurality of opening holes 422 by, for example, patterning using a photolithography technique.

The optical filter 42 having such a metal mesh structure well transmits light of a specific wavelength band and indicates a band-pass characteristic of reflecting a light other than the specific wavelength band. The arrangement period (the center interval between the nearest opening holes 422) d in the lattice according to the opening holes 422 is designed to be smaller than a wavelength of a light to be transmitted. In the present embodiment, the optical filter 42 is designed to transmit light with a wavelength of the fluorescence F emitted from the inspection target 50 and reflect light with a wavelength of the excitation light EL.

FIG. 6C is a top view illustrating an optical filter 43 having another metal mesh structure. The optical filter 43 has a capacitive mesh structure in which rectangular shape metal portions 431 formed of a metal material are arranged at equal intervals in a vertical direction and a horizontal direction, and an insulating film portion 432 excluding the metal portions 431 is formed in a lattice shape. A shape of the metal portion 431 is not limited to the illustrated rectangular shape, and may be any shape.

The optical filter 43 having such a capacitive mesh structure has a band-stop characteristic that reflects a light of a specific wavelength band well, and transmits a light outside the specific wavelength band. In the optical filter 43, the arrangement period d in a lattice shape is designed to be smaller than a wavelength of a light to be reflected.

By this, the optical filter 43 of the fluorescence detection sensor 1 can be configured to transmit light with the wavelength of the fluorescence F emitted by the inspection target 50 and reflect light with the wavelength of the excitation light EL. The excitation light EL is reflected by the optical filter 43 so that the primary fluorescence F1 and the secondary fluorescence F2 can be selectively guided to the photon detection unit 32.

### Measurement Sequence of Fluorescence Detection Sensor 1

Using the fluorescence detection sensor 1 according to Embodiment 2, the excitation light EL is reflected by the optical filter 12 and the primary fluorescence F1 and the secondary fluorescence F2 can be selectively guided to the photon detection portion 11 by the same measurement sequence as Embodiment 1 (see FIGS. 1A and 1B).

Further, according to the fluorescence detection sensor 1 in Embodiment 2, when a plurality of types of phosphors emitting fluorescence F with respect to the same excitation light wavelength are mixed as an inspection target 50, it is possible to detect a certain phosphor. For example, when phosphors that emit the fluorescence F by blue excitation light having a wavelength of 488 nm such as FITC (maximum fluorescence wavelength 525 nm), PE (maximum fluorescence wavelength 575 nm), PI (maximum fluorescence wavelength 620 nm), or the like are mixed with each other, the fluorescence detection sensor 1 is configured to include a metal mesh structure having a band-pass characteristic of transmitting light with a wavelength around 575 nm as the optical filter 42, it becomes possible to exclude the fluorescence F by the FITC and the PI and detect only the fluorescence F by the PE.

### Fluorescence Detection System Including Fluorescence Detection Sensor 1

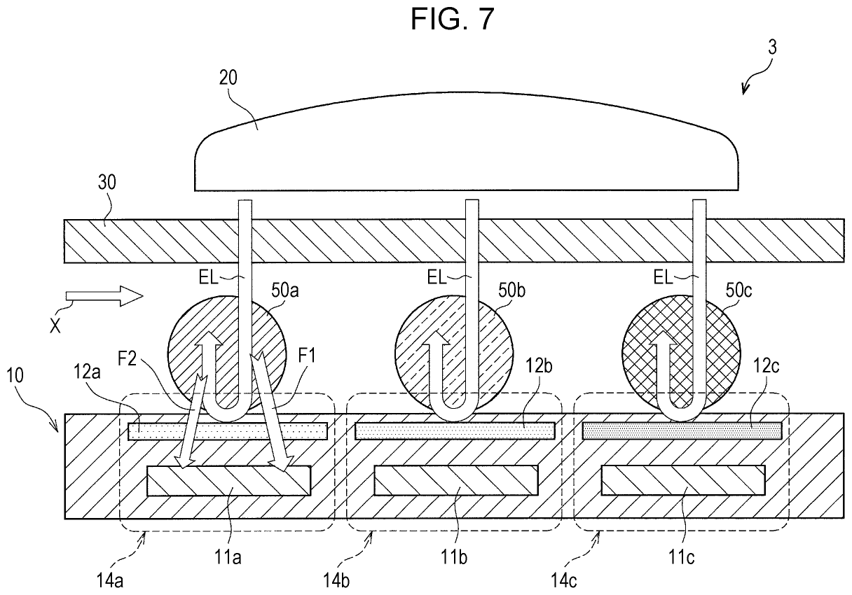

FIG. 7 is an explanatory view illustrating a configuration of a fluorescence detection system provided with the fluorescence detection sensor 1 according to Embodiment 2. In the fluorescence detection system, classification of an inspection target based on a wavelength of fluorescence is enabled by a configuration and an operation described below.

As illustrated in FIG. 7, three units 14a, 14b, and 14c each including the optical filter 12 and the photon detection portion 11 are taken as an example. The optical filters 12a, 12b, and 12c included in the first to third units 14a, 14b, and 14c are designed such that each of the peak wavelengths of the filter characteristics becomes a different wavelength. The first to third units 14a, 14b, and 14c are disposed in the same semiconductor substrate 10. The first to third units 14a, 14b, and 14c are provided with a common excitation light source 20, and are respectively provided with first to third optical filters 12a, 12b, and 12c.

For example, the first optical filter 12a provided in the first unit 14a has a pass wavelength of 525 nm in accordance with the FITC. The second optical filter 12b provided in the second unit 14b has a peak wavelength of 575 nm in accordance with the PE. Further, the third optical filter 12c provided in the third unit 14c has a peak wavelength of 620 nm in accordance with the PI.

In the fluorescence detection system, a flow path 30 for circulating the inspection target is formed on the semiconductor substrate 10. The inspection target 50 is configured to flow in the flow path 30 in an arrow X direction, and passes over the first to third units 14a, 14b, and 14c along the flow. A material of a flow path 30 constituting the flow path 30 is not particularly limited, and, for example, the material is formed of a polydimethylsiloxane (PDMS) which is one of silicone rubbers, and transmits light with a wavelength of the excitation light EL radiated from the excitation light source 20.

In FIG. 7, three types of cells 50a, 50b, and 50c are illustrated as inspection targets. These cells 50a, 50b, and 50c are dyed by the fluorescent labeling reagents FITC, PE, PI, respectively. The cells 50a, 50b, and 50c are mixed with each other and dispersed in a buffering solution.

By flowing the buffering solution in which the cells 50a, 50b, and 50c are dispersed into the flow path 30, as illustrated in FIG. 7, any one cell (50a, 50b, and 50c) reaches the first to third units 14a, 14b, and 14c. Then, in each of the first to third units 14a, 14b, and 14c, the measurement sequence is continuously performed.

For example, when the fluorescence F is detected by the first unit 14a, a cell passing over the first unit 14a can be identified as the cell 50a dyed with the FITC. The fluorescence F is similarly detected for the combination of the second unit 14b and the cell 50b, and the combination of the third unit 14c and the cell 50c, whereby the identification of the respective cells 50b and 50c becomes possible.

In the embodiment illustrated in FIG. 7, the cell 50a is positioned on the first unit 14a, the cell 50b is positioned on the second unit 14b, and the cell 50c is positioned on the third unit 14c. As a result, the fluorescence F (F1 and F2) are detected by the first unit 14a, whereas the fluorescence F is not detected by the other units 14b and 14c. By this, it is identified that the cell 50a is the inspection target on the first unit 14a.

Thereafter, along the flow in the flow path 30, these cells 50a, 50b, and 50c flow in the arrow X direction. For example, the cell 50c positioned on the third unit 14c at the beginning (state illustrated in FIG. 7) is positioned on the second unit 14b. Then, the fluorescence F (F1 and F2) emitted from the cell 50c are detected by the second unit 14b. As a result, it is identified that the inspection target positioned on the second unit 14b is the cell 50c.

In this way, in the fluorescence detection system using the fluorescence detection sensor 1 (fluorescence detection sensor including the first to third units 14a, 14b, and 14c) according to Embodiment 2, even when a plurality of types of phosphors emitting the fluorescence F with respect to the same excitation light wavelength are dispersed and mixed to each other in a liquid, it becomes possible to detect a specific phosphor, and possible to be suitably applied to a classification of the inspection target.

### Embodiment 3

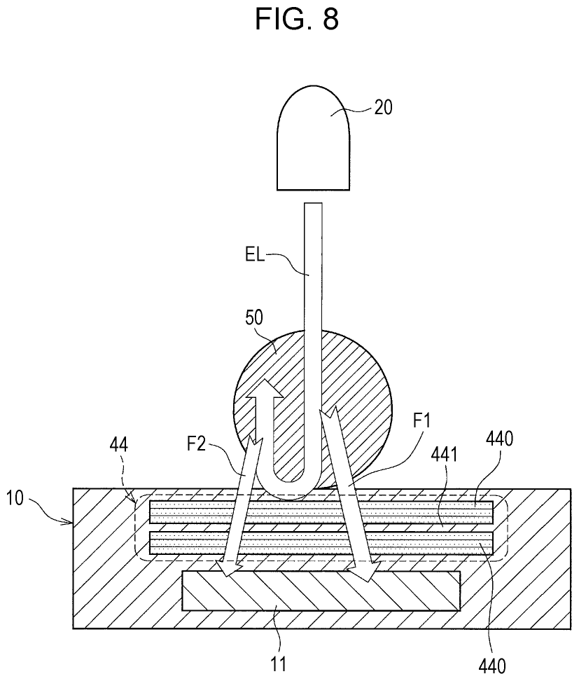

FIG. 8 is an explanatory view illustrating a configuration of the fluorescence detection sensor 1 according to Embodiment 3. The fluorescence detection sensor 1 according to this embodiment is characterized in that it includes an optical filter 44 having a plurality of optical filter layers 440 as compared with the fluorescence detection sensor 1 according to Embodiment 1.

As illustrated in FIG. 8, the optical filter 44 of the fluorescence detection sensor 1 is configured such that two optical filter layers 440 are laminated with an interlayer insulating film layer 441 interposed therebetween. The optical filter layer 440 has a configuration common to any of the optical filters 12, 42, and 43 illustrated in Embodiments 1 and 2.

In such an optical filter 44, a light resonance occurs between the optical filter layers 440, and a ratio of the transmittance of a wavelength to be mostly transmitted to the transmittance of the other wavelengths becomes large. That is, in the fluorescence detection sensor 1, a separation performance of the excitation light EL and the fluorescence F can be improved by performing an appropriate dimensioning the optical filter layer 440.

Note that the combination of a pattern and a dimension of the optical filter layer 440 can be randomly determined in accordance with the purpose. By combining and laminating different optical filter layers 440, transmission characteristics such as band-pass characteristics, band-stop characteristics, longpass characteristics, or shortpass characteristics can be obtained. However, since the fluorescence wavelength is generally longer than the excitation light wavelength, the short path characteristic is not used in the present embodiment. In the present embodiment, the optical filter 44 is configured with the two optical filter layers 440, but the combination of three or more layers can be similarly designed to obtain desired transmission characteristics.

In the fluorescence detection sensor 1 according to Embodiment 4, the excitation light EL is reflected by the optical filter 44 and the primary fluorescence F1 and the secondary fluorescence F2 can be selectively guided to the photon detection portion 32 by the same measurement sequence as the fluorescence detection sensor 1 according to Embodiment 1.

### Embodiment 4

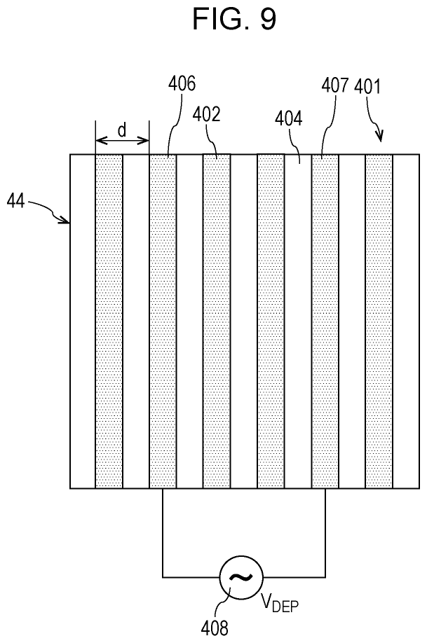

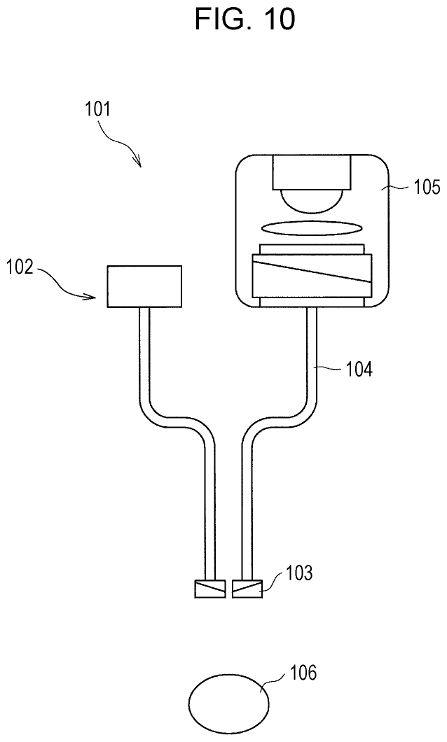

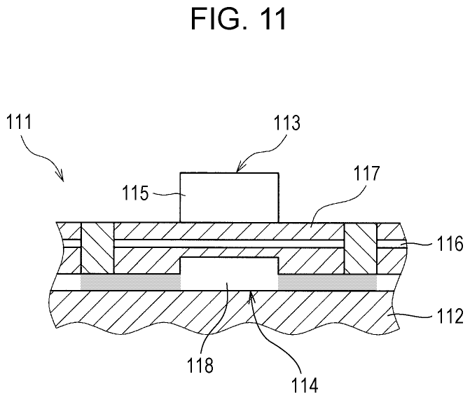

Next, as for Embodiment 4, a fluorescence detection system using the fluorescence detection sensor 1 will be described. FIG. 9 is an explanatory view of a case where specific wiring electrodes 406 and 407 constituting the optical filter 12 described in FIG. 3 are operated as dielectrophoretic electrodes. The dielectrophoretic force F_{DEP} exerted by the wiring electrodes 406 and 407 on the cells 50 (not shown) is expressed by following Expression 2.

$${F}_{DEP} = 2 {π ( \frac{d}{2} )}^{3} {ɛ}_{m} Re [ \frac{{ɛ}_{p}^{*} - {ɛ}_{m}^{*}}{{ɛ}_{p}^{*} + 2 {ɛ}_{m}^{*}} ] \qquad Expression 2$$

d is a diameter of a cell, εₚ* and εₘ* are complex dielectric constants of the cell and a solvent, respectively, and E is an electric field applied by an electrode.

By using Expression 2 and the positive and negative of the real component of the CM factor illustrated in following Expression 3, it can be calculated whether the cell is attracted to the electrode or leaves the electrode by repulsion by the dielectrophoretic force F_{DEP}.

$$\frac{{ɛ}_{p}^{*} - {ɛ}_{m}^{*}}{{ɛ}_{p}^{*} + 2 {ɛ}_{m}^{*}} \qquad Expression 3$$

When a value of Re[(εₚ*−εₘ*)/(εₚ*+εₘ*)] in above Expression 2 is positive, the force toward the electric field applied by the electrode, that is, the positive dielectrophoretic force F_{DE}, works with respect to the cells 50. On the other hand, when a value of Re[(εₚ*−εₘ*)/(εₚ*+εₘ*)] in above Expression 2 is negative, a force to repel against the electric field applied by the wiring electrodes 406 and 407, that is, a negative dielectrophoretic force F_{DEP}, works with respect to the cells 50.

In a case of the configuration of the optical filter 44 illustrated in FIG. 9, by applying a voltage signal V_{DEP} that generates a positive dielectrophoretic force F_{DEP} from a signal source 408 to the wiring electrodes 406 and 407, the cells 50 present in the vicinity of the wiring electrodes 406 and 407 are attracted to the wiring electrodes 406 and 407. It is desirable that the other electrodes be in an electrically floating state to avoid interference with the electric field generated from the wiring electrodes 406 and 407. As described above, it is possible to stop the cells 50 on the fluorescence detection sensor 1 and detect the fluorescence F.

On the other hand, by applying a voltage signal that generates a negative dielectrophoretic force F_{DEP} from the signal source 408 to the wiring electrodes 406 and 407, unwanted cells 50 present in the vicinity of the wiring electrodes 406 and 407 can be kept away from the wiring electrodes 406 and 407, that is, the fluorescence detection sensor 1.

Note that in addition to the fluorescence detection sensor 1 illustrated in Embodiment 1, the fluorescence detection sensor 1 illustrated in Embodiments 2 to 4 can be similarly applied to the fluorescence detection system according to the present embodiment, and the optical filter 12 may also have an optical filter configuration in another form.

As described above, in the fluorescence detection sensor 1 and the fluorescence detection system according to the present disclosure, the fluorescence F emitted from the inspection target 50 can be separated from the excitation light EL via the optical filter 12, and a highly sensitive fluorescence detection can be performed.

Note that although the embodiments of the fluorescence detection sensor and the fluorescence detection system according to the present disclosure is described, the present disclosure is not limited to the above-described configurations, various modifications can be made within the scope of the claims, and embodiments obtained by appropriately combining the technical means each disclosed in different embodiments are also included in the technical scope of the present disclosure. Furthermore, new technical features can be formed by combining the technical means disclosed in each embodiment.

The present disclosure contains subject matter related to that disclosed in Japanese Priority Patent Application JP 62/685495 filed in the Japan Patent Office on Jun. 15, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A fluorescence detection sensor comprising:
an excitation light source that irradiates an inspection target with excitation light;
a semiconductor integrated circuit provided with a photon detection portion that detects light by a photodiode; and
a control unit that causes the inspection target maintained on the photodiode to be irradiated with the excitation light, and detects, by the photon detection portion, fluorescence emitted from the inspection target after the excitation light is quenched,
wherein an optical filter formed by a metal wiring layer which is one of components of the semiconductor integrated circuit, is provided above the photon detection portion.

2. The fluorescence detection sensor according to claim 1,
wherein the optical filter is configured to cover a section in which the photodiode is formed,
wherein the optical filter and the photodiode are formed as one unit cell independently of other photodiodes, and
wherein an array includes unit cells, each of which is the unit cell formed by the optical filter and the photodiode, and the array is formed on the semiconductor substrate.

3. The fluorescence detection sensor according to claim 1,
wherein the excitation light source emits a linearly polarized light, and
wherein the optical filter has optical characteristics as a polarizer.

4. The fluorescence detection sensor according to claim 1,
wherein the optical filter has a metal mesh structure in which a plurality of opening holes are evenly arranged.

5. The fluorescence detection sensor according to claim 1,
wherein part of metal wiring forming the optical filter is wiring to which a dielectrophoretic signal given from a signal source is given, and has a mechanism for maintaining the inspection target by a dielectrophoretic force.

6. The fluorescence detection sensor according to claim 1,
wherein metal wiring forming the optical filter is formed by utilizing at least two metal wiring layers, each of which is the metal wiring layer which is one of the components of the semiconductor integrated circuit.
